(19) United States
(12) Patent Application Publication
(10) Pub. No.: US 2005/0217172 A1
(43) Pub. Date: Oct. 6, 2005

(54) Watering device for watering plant containers and watering arrangement formed therewith

(75) Inventors: Hermann Korte, Surwold (DE); Rudolf Schomaker, Sogel (DE); Reinhold Trinczek, Grabau (DE)

Correspondence Address: FULBRIGHT & JAWORSKI, LLP, 1301 MCKINNEY, SUITE 5100, HOUSTON, TX, 77010-3095, US

(73) Assignee: Dipl.-lng. Hermann Korte, Surwold (DE)

(21) Appl. No.: 11/063,161

(22) Filed: Feb. 22, 2005

(30) Foreign Application Priority Data
Mar. 3, 2004 (DE) 202004003486.7

(51) Int. Cl. A01G 29/00

(52) U.S. Cl. 47/48.5

(57) ABSTRACT

A watering device for watering plant containers that includes a distribution head which can be connected to a water pipe and a plurality of delivery pipes beginning at the distribution head and ending unattached. At least one delivery pipe and/or the distribution head has a mounting device associated with it, in which the device can be laid on or hung from an edge of one or more plant containers.

### CROSS-REFERENCE TO RELATED APPLICATIONS

This application claims priority to DE 202004003486.7 filed Mar. 3, 2004.

### TECHNICAL FIELD

The invention relates to a watering device for watering plant containers, the watering device being particularly suitable for watering transport containers (trolley containers) equipped with a plurality of storage platforms arranged one on top of the other like shelves for plants.

### BACKGROUND OF THE INVENTION

In the plant trade, it is difficult, labor-intensive and time-consuming to provide watering that takes into account the different requirements of the varying species and sizes of plants when the individual plants are arranged in pots or the like on trolley containers, because each individual trolley container needs to be supplied with a particular amount of water, which in some cases can vary from one trolley container to another.

If the storage platforms in the trolley container are pan-shaped and are provided with overflows, this is already enough to achieve a considerable reduction in the effort involved in watering, because then only the topmost storage platform in each case has to be watered, since the overflow effect means that the platforms and plants below automatically receive water. Even in this case, however, a controlled supply of water for each trolley container is needed.

The object of the invention therefore consists in creating a watering device for watering plant containers, especially for watering trolley containers with storage platforms arranged one on top of the other which are pan-shaped and are provided with overflows.

### BRIEF SUMMARY OF THE INVENTION

This object is achieved in accordance with the invention by a watering device for watering plant containers, with a distribution head which can be connected to a water pipe and a plurality of delivery pipes beginning at the distribution head and ending unattached, at least one delivery pipe and/or the distribution head having a mounting device associated with it, with which the device can be laid on or hung from an edge of one or more plant containers.

Each delivery pipe preferably has a mounting device associated with it.

The delivery pipes are advantageously made from a dimensionally stable material and form the mounting devices.

The invention preferably provides for the mounting devices to be flexible, freely deformable and dimensionally stable, so that they can be deformed but are nevertheless capable of supporting a weight.

The mounting devices may be tubular, and they can be formed from a metal section wound into a tubular shape. In addition, it can be provided for the delivery pipes to be formed by a water-tight interior surface of the mounting devices, and in particular by hose pipes disposed in the mounting devices.

The invention preferably provides that the delivery pipes are mounted in the distribution head in such a way that they can be twisted.

The delivery pipes may be C or U-shaped, or capable of being turned into such a shape.

It can be provided that the valve block has a manifold with bore holes, a delivery pipe being mounted in each bore hole such that it is sealed and capable of being twisted.

A central check valve can be disposed in the region of a connection end of the distribution head, which can be connected to the water pipe. Alternatively or in addition, a time-controlled check valve can be disposed as a watering timer in the region of a connection end of the distribution head, which can be connected to the water pipe. Both the time, such as a fixed time of day, and the amount of water to be delivered at that time, or the watering time can be controllable.

In addition, it can be provided that each delivery pipe has an individual check valve associated with it, which can likewise be time-controlled in the sense described above.

In accordance with the invention, it can further be provided that at least one of the delivery pipes is extendible, especially telescopically, and preferably that it is telescopically extendible at its unattached end. This means that it is possible, when watering trolleys whose topmost storage platforms are attached at different heights, to arrange the outlet end of the delivery pipes directly at the level of the individual storage platforms. From the design point of view, the extendibility could be achieved, for example, by providing the or each delivery pipe with a number of pieces of pipe of different diameters which can by slid telescopically into or out of each other.

The object the invention is further achieved by a watering arrangement with one or more watering devices in accordance with the invention, with a standing surface for plant trolleys, above which a horizontal guide rail and a water pipe are arranged at a vertical distance, each watering device being connected to the water pipe via a flexible supply pipe and hung on the guide rail, and being guided so as to be horizontally displaceable within a displacement range. If, as is preferably provided, a plurality of watering devices are connected, their flexible supply pipes are spaced apart from one another in their connection to the water pipe .

A roof can be arranged over the guide rail to protect the plants placed on the plant trolley.

It is preferably envisaged that the water pipe is provided with a timer so that plant trolleys placed beneath the guide rail can be watered at predetermined times and for predetermined durations or with predetermined amounts of water. Alternatively or in addition, the watering devices can be provided with the above-mentioned timers (time-controlled check valves).

### BRIEF DESCRIPTION OF THE DRAWINGS

Other advantages and features of the invention will become apparent from the following description of a working embodiment of a watering device and a watering arrangement, reference being made to a drawing, in which:

FIG. 1 shows a side view of a watering device in accordance with the invention;

FIG. 2 shows a perspective view of the watering device of FIG. 1 used for watering four trolley containers;

FIG. 3 shows a schematic, enlarged longitudinal section view of the watering device of FIG. 1;

FIG. 4 shows a perspective view of a section of a watering arrangement in accordance with the invention;

FIG. 5 shows an extended section of the watering arrangement of FIG. 4 on a somewhat smaller scale;

FIG. 6 shows a front view of the watering arrangement of FIGS. 4 and 5; and

FIG. 7 shows part of a view of the watering arrangement of FIGS. 4 to 6 from the top.

### DETAILED DESCRIPTION OF THE INVENTION

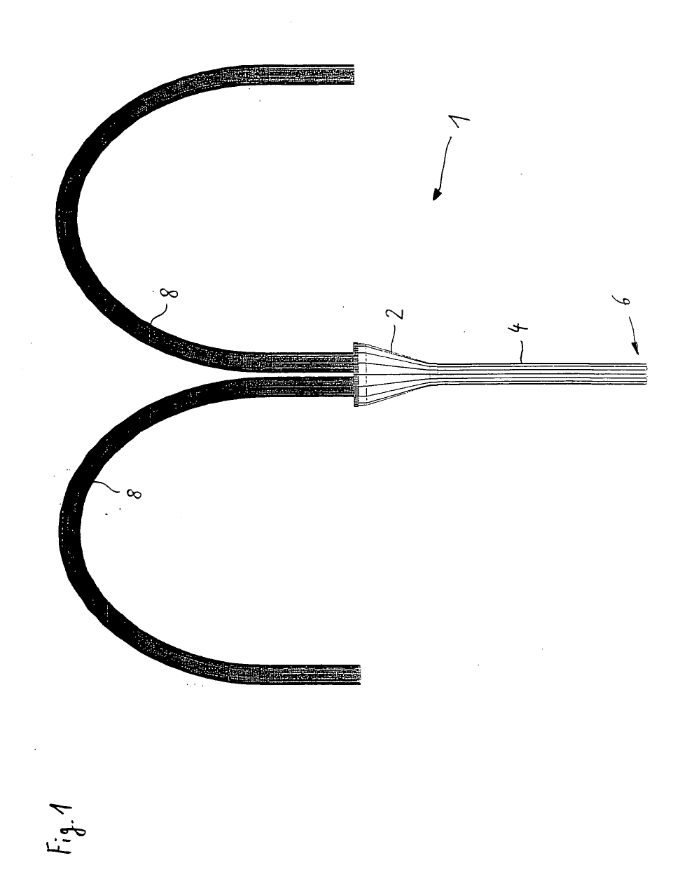

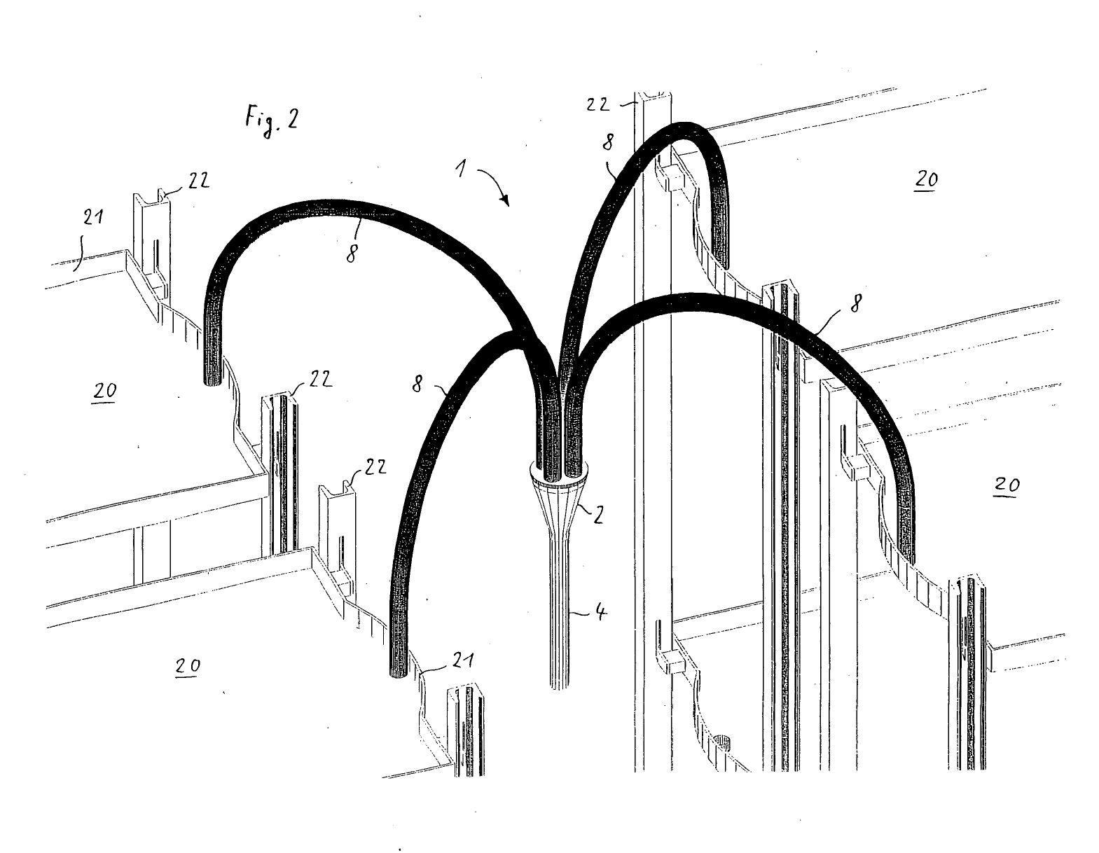

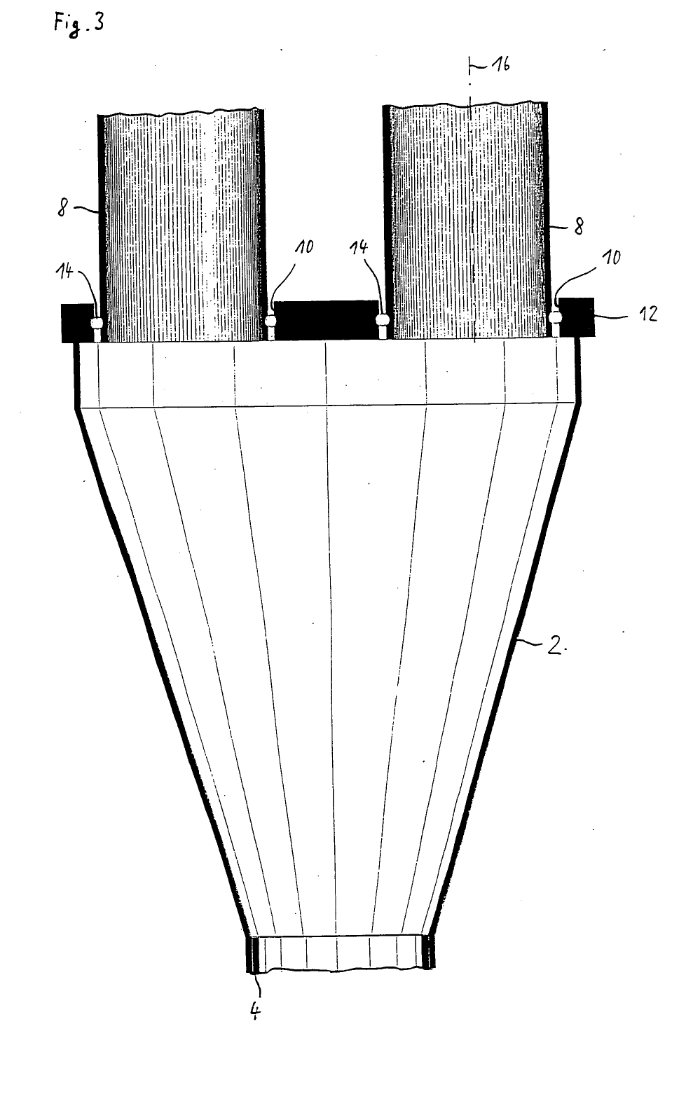

Reference should first be made to FIGS. 1 to 3, which illustrate a watering device in accordance with the invention designated as a whole by 1. FIG. 1 shows a side view and FIG. 2 a perspective view diagonally from above, where one first sees a distribution head 2 and, attached to it, firstly a connection pipe 4 with a connection end 6 and, secondly, a number of delivery pipes 8 (four in this example) at the top. As can be seen from FIG. 3, which shows a longitudinal section through part of the delivery pipe 8, the distribution head 2 and part of the connection pipe 4 on an enlarged scale, the delivery pipes 8 are inserted by their lower unattached end portions in bore holes 10 of a manifold 12 of the distribution head 2, with a sealing ring 14 inserted in each case between interior surfaces of the bore holes 10 and exterior surfaces of the delivery pipes 8 to create a seal. Because of this arrangement, each delivery pipe 8 can be rotated about a longitudinal axis 16 of the bore hole 10 associated with it, so that adaptation to different geometries of plant containers is possible.

As FIG. 3 also shows, the distribution head 2 is designed as a rotationally symmetrical hollow body, which terminates at its upper end with the manifold 12 and is connected at its lower end to the connection pipe 4. This ensures that water delivered through the connection pipe 4 is fed evenly to the four delivery pipes 8 as it flows through.

In the embodiment described here, the delivery pipes 8 are formed from a dimensionally stable material which is nevertheless flexible and freely deformable within certain limits, so that each individual delivery pipe 8 can be bent into a desired shape, especially in the C and U-shapes shown in FIGS. 1 and 2. Because of the dimensionally stable construction of the delivery pipes, they at the same time form mounting means for the watering device as a whole, so that, as shown in FIG. 2, the latter can be placed on top of individual plant containers 20 or hung over the edge or side wall 21 of the latter by means of the delivery pipes 8, which are bent like hooks or holding means.

Instead of or in addition to the delivery pipes forming mounting means, the invention also contemplates mounting means associated with the distribution head and being provided separately from the delivery pipes.

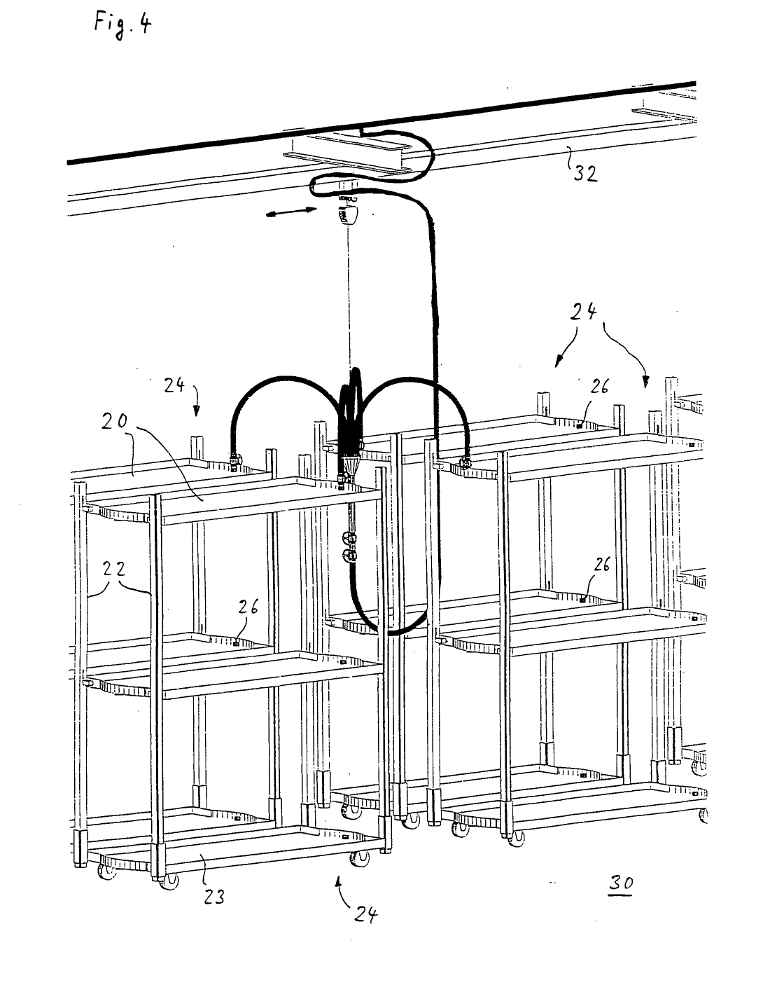

The plant containers 20 are in this case designed as pan-shaped storage platforms, which are mounted one on top of the other like shelves on rack struts 22. As FIGS. 4 to 6 show, a number of plant containers or storage platforms 20 and four rack struts 22 in each case, together with a shelf platform 23 fitted with rollers, form a transport container or trolley 24.

The delivery pipes 8 can be designed to be flexible by having them made, for example, from a helically wound metal section which is provided with a water-tight seal on the inside or which has a hose pipe guided inside it.

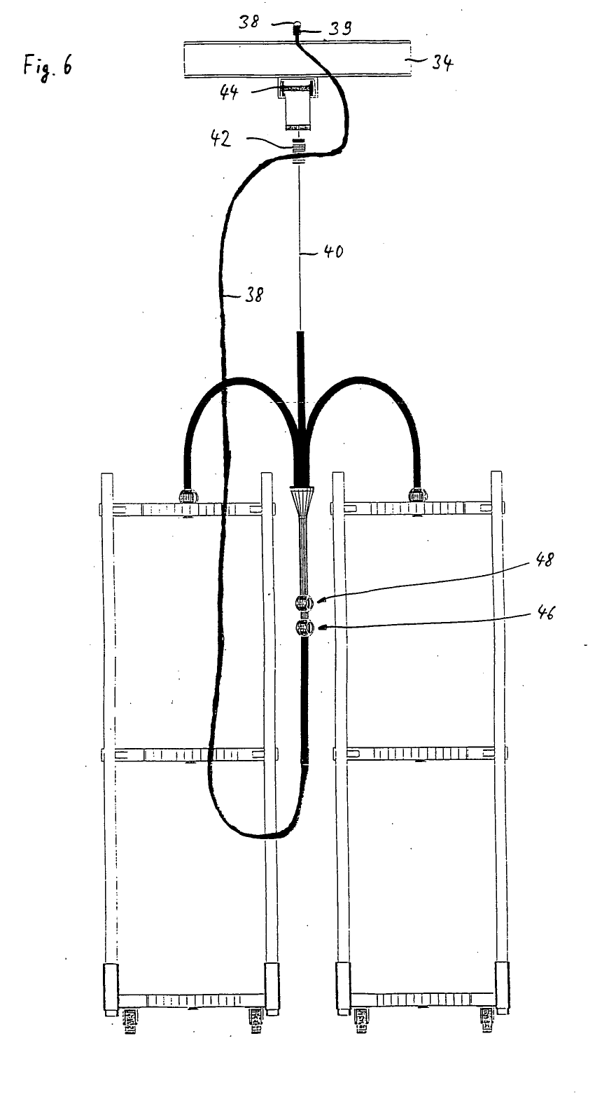

It is convenient for a central check valve 46 (FIG. 6) to be provided in the connection pipe 4, possibly supplemented by a further, time-controlled, check valve 48 (FIG. 6, watering timer), so that the watering device 1 can, on the one hand, be sealed off completely and, on the other hand, when it is not in the sealed state, can perform a watering action, under the time control of the watering timer, on those four trolleys 24 in whose uppermost storage platforms it is hung.

In addition, it can be appropriate for an individual check valve to be provided in each separate delivery pipe 8, which check valve could also be designed as an individual watering timer. In this way, it is possible to water the four trolleys 24 associated with the watering device 1 according to an individual timer, which is different in each case, with different amounts of water and/or at different times.

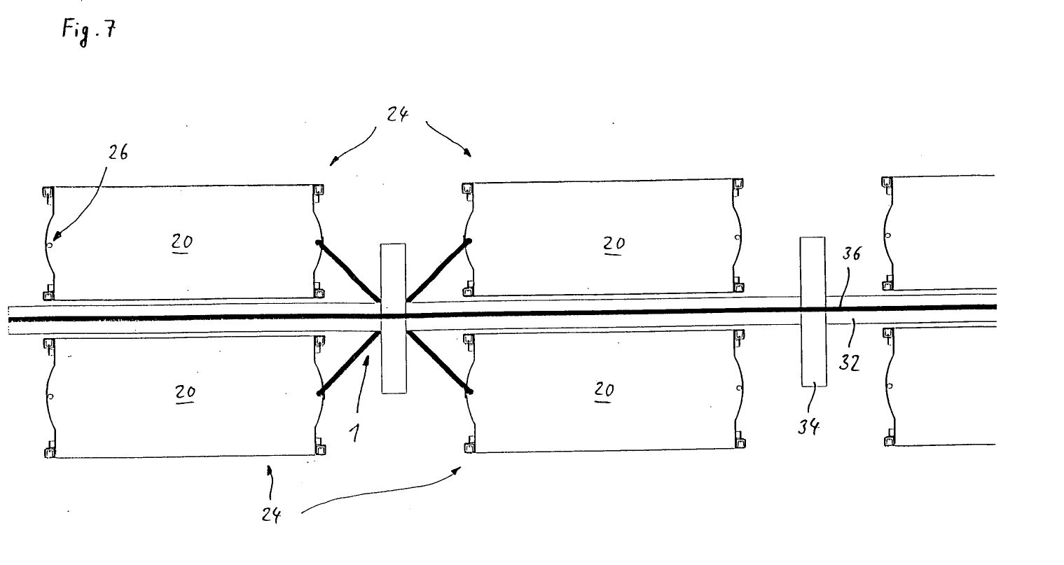

As FIG. 4 and the top plan view of FIG. 7 also show, each plant container or each storage platform 20 is provided with an overflow 26, which allows the water to run over into the plant container or storage platform 20 below as soon as a predetermined water level is reached, so that all the storage platforms 20 are watered successively from above.

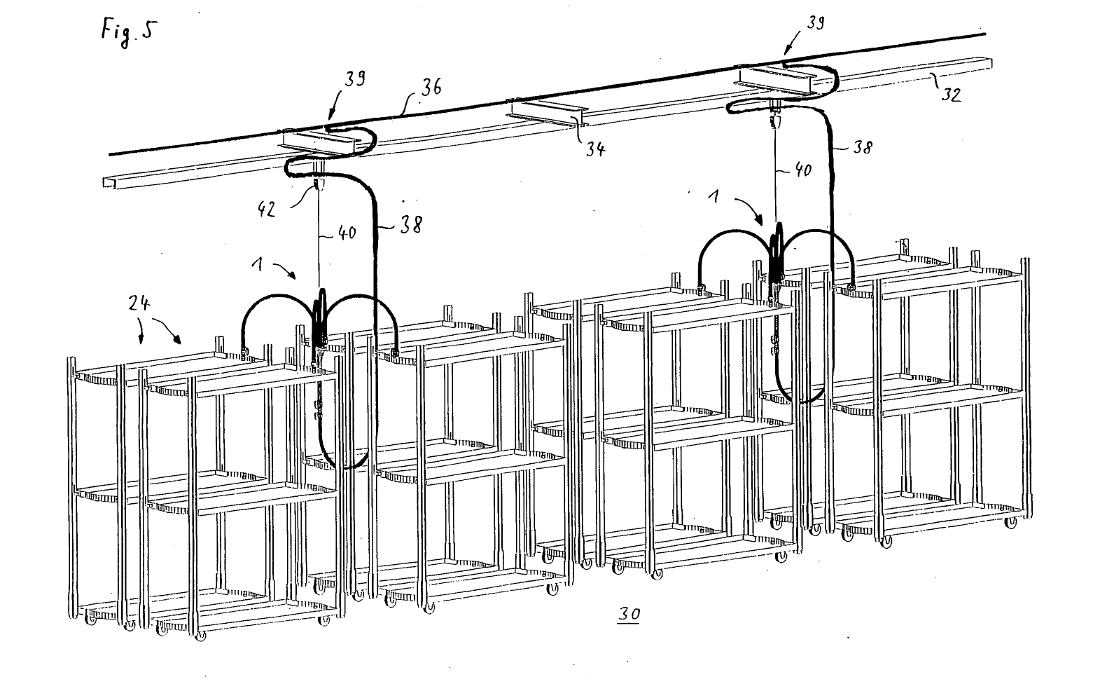

FIGS. 4 to 6 show how the individual watering devices 1 are hung from a supporting and guide rail 32 arranged horizontally some distance above the surface 30 on which the trolleys 24 are standing, wherein, depending on the number of trolleys 24 to be supplied, the necessary number of watering devices 1 are mounted in series at appropriate intervals (FIG. 5) on the guide rail 32, which is designed with the corresponding length.

As can be seen from FIGS. 5 and 6 in particular, the guide rail 32 is attached by means of cross-members 34 arranged at intervals to a shed ceiling, roof or the like, a water pipe 36 being laid parallel and adjacent to the guide rail 32, to which the watering devices 1 are connected at 39 by means of a flexible hose pipe 38. Each watering device 1 is suspended from a supporting cable 40, which can be unwound from a cable drum 42 as needed, and then wound back into it, the cable drum 42 for its part being mounted on rollers 44 inside the guide rail 32, which is designed in a double C-shape, and being guided such that it can be longitudinally displaced. When a watering device is not needed, it thus hangs in readiness on the cable 42 at an appropriate height where it can be reached.

FIG. 7 schematically shows the watering arrangement in a top plan view from above, wherein the water pipe 36, the guide rail 32, a watering device 1 with its four delivery pipes 8 and the four trolleys 24 associated with the watering device 1 and watered by it can be seen. The hose pipe 38 (see also FIG. 5) is preferably at least of such a length that each watering device 1 is capable, on the one hand, of watering the group of four trolleys 24 which are located directly beneath the connection point between the hose pipe 38 and the water pipe 36 (on the left and right in FIG. 5), or alternatively also each group of four trolleys immediately adjacent to it on the left (in the middle in FIG. 5).

For the purpose of re-using the water flowing out of the bottom-most storage platforms, it can be provided that it is caught in the region of the standing surface 30, collected and then, after being topped up with fresh water, optionally with fertilizers, nutrients etc. added, fed into the water pipe 36.

1. A watering device for watering plant containers comprising:
a distribution head which can be connected to a water pipe;
a plurality of delivery pipes beginning at the distribution head and ending unattached;
at least one delivery pipe and/or the distribution head having a mounting device associated with it, wherein the watering device can be laid on or hung from an edge of one or more plant containers.

2. The watering device as claimed in claim 1, wherein each delivery pipe has a mounting device associated with it.

3. The watering device as claimed in claim 1, wherein the delivery pipes are made from a dimensionally stable material and form the mounting devices.

4. The watering device as claimed in claim 1, wherein the mounting devices are flexible, freely deformable and dimensionally stable.

5. The watering device as claimed in claim 1, wherein the mounting devices are tubular.

6. The watering device as claimed in claim 1, wherein the mounting devices are formed from helically wound metal sections.

7. The watering device as claimed in claim 5 and 6, wherein the delivery pipes are formed by a water-tight interior surface of the mounting devices.

8. The watering device as claimed in claim 7, wherein the delivery pipes are formed by hose pipes disposed in the mounting devices.

9. The watering device as claimed in claim 1, wherein the delivery pipes are mounted in the distribution head in such a way that they can be twisted.

10. The watering device as claimed in claim 1, wherein the delivery pipes are C or U-shaped.

11. The watering device as claimed in claim 10, wherein the delivery pipes are capable of being turned into the C or U shape.

12. The watering device as claimed in claim 1, wherein the distribution head has a manifold with bore holes and a delivery pipe is mounted in each bore hole such that it is sealed and capable of being twisted.

13. The watering device as claimed in claim 1, wherein a central check valve is disposed in the region of a connection end of the distribution head, in which the central check valve can be connected to the water pipe.

14. The watering device as claimed in claim 1, wherein a time-controlled check valve is disposed as a watering timer in the region of a connection end of the distribution head, in which the time-controlled check valve can be connected to the water pipe.

15. The watering device as claimed in claim 1, wherein each delivery pipe has a check valve associated with it.

16. The watering device as claimed in claim 15, wherein the check valve is time-controlled.

17. The watering device as claimed in claim 1, wherein at least one of the delivery pipes is telescopically extendible.

18. The watering device as claimed in claim 17, wherein the delivery pipe is telescopically extendible at its unattached end.

19. A watering arrangement comprising:
a plurality of plant containers standing on a surface;
a horizontal guide rail and a water pipe arranged at a vertical distance above the surface;
one or more watering devices comprising a distribution head which can be connected to a water pipe, a plurality of delivery pipes beginning at the distribution head and ending unattached, and at least one delivery pipe and/or the distribution head having a mounting device associated with it;
wherein each watering device is connected to the water pipe via a flexible supply pipe and configured to hang on the guide rail, such that the watering device is horizontally displaceable within a displacement range.

20. The watering arrangement as claimed in claim 19, wherein the one or more watering devices are spaced apart from one another.

21. The watering arrangement as claimed in claim 19, wherein a roof is arranged over the guide rail.

22. The watering arrangement as claimed in claim 19, wherein each of the plurality of plant containers include spaced apart shelves mounted one on top of the other.

23. The watering arrangement as claimed in claims 19, wherein the water pipe is provided with a timer so that plurality of plant containers placed beneath the guide rail are watered at predetermined times and for predetermined durations and/or with predetermined amounts of water.
